(19) United States
(12) Patent Application Publication
(10) Pub. No.: US 2008/0306819 A1
(43) Pub. Date: Dec. 11, 2008

(54) SYSTEM AND METHOD FOR SHAPING RELEVANCE SCORES FOR POSITION AUCTIONS

(75) Inventors: Pavel Berkhin, Sunnyvale, CA (US); Chad Carson, Cupertino, CA (US); Ashvin Kannan, Sunnyvale, CA (US); Darshan Kantak, Pasadena, CA (US); Sebastian Lahaie, Cambridge, MA (US); Christopher LuVogt, San Francisco, CA (US); Jan Pedersen, Los Altos Hills, CA (US); David M. Pennock, Monroe Township, NJ (US); Tong Zhang, Tuckahoe, NY (US)

Correspondence Address: YAHOO! INC.;C/O DREIER LLP, 499 PARK AVENUE, NEW YORK, NY, 10022, US

(73) Assignee: YAHOO! INC., Sunnyvale, CA (US)

(21) Appl. No.: 11/760,069

(22) Filed: Jun. 8, 2007

(51) Int. Cl. G06Q 30/00

(52) U.S. Cl. 705/14

(57) ABSTRACT

The present invention is directed towards systems and methods for ranking and providing advertisements in a position auction. The method of the present invention comprises receiving a search query and selecting at least one keyword based upon the search query. A list containing at least one keyword based upon the search query is returned and a list comprising at least one bid corresponding to the returned list of keywords is retrieved. A priority score corresponding to each bid is computed and used to rank the list of bids. Advertisements are then provided corresponding to a plurality of the highest ranking bids.

### CROSS REFERENCE TO RELATED APPLICATIONS

The present application is related to the following co-owned U.S. Patent Applications:

U.S. patent application Ser. No. 11/281,919, entitled “SYSTEM AND METHOD FOR REVENUE BASED ADVERTISEMENT PLACEMENT,” filed on Nov. 16, 2005 and assigned attorney docket no. 600189.289;

U.S. patent application Ser. No. 11/281,940, entitled “POSITIONING ADVERTISEMENTS ON THE BASIS OF EXPECTED REVENUE,” filed on Nov. 16, 2005 and assigned attorney docket no. 600189.290;

U.S. patent application Ser. No. 11/281,917, entitled “SYSTEM AND METHOD FOR DISCOUNTING OF HISTORICAL CLICK THROUGH DATA FOR MULTIPLE VERSIONS OF AN ADVERTISEMENT,” filed on Nov. 16, 2005 and assigned attorney docket no. 600189.291;

U.S. patent application Ser. No. 11/479,186, entitled “SYSTEM AND METHOD FOR GENERATING FUNCTIONS TO PREDICT THE CLICKABILITY OF {00237458.DOC;3} ADVERTISEMENTS,” filed on Jun. 29, 2006 and assigned attorney docket no. 600189.299;

the disclosures of which are hereby incorporated by reference herein in their entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to shaping relevance scores for position auctions. More specifically, the present invention is directed to systems and methods for providing allocation and payment rules to optimize search engine revenue via advertising position auctions.

### BACKGROUND OF THE INVENTION

Major search engines such as Yahoo!, which are advertisement providers, generate revenue by auctioning advertising space on keyword search result pages. This revenue is often a primary source of revenue for many search engines, globally generating roughly $7 billion a year for businesses. It is therefore important to advertisement providers that customer satisfaction and generated revenue be maximized to the extent possible.

A common technique that advertisement providers use (such as search engines) is that of a position auction. When users search for keywords in a corpus of documents, the results are returned to along with relevant advertisements, usually located on the top, bottom or side of the returned results. In a position auction, advertisers submit bids corresponding to desired keywords. For example, a company may decide to bid $1 per user click for the keyword “acoustic guitar”. Subsequent users may decide to bid on the same keyword with a higher or lower bid. After advertisers submit bids and corresponding advertisements, the advertisement provider ranks the advertisements to determine an appropriate order or position for presentation of the advertisements to the user.

Techniques to rank advertisements in position auctions include rank-by-bid and rank-by-revenue. In a rank-by-bid scheme, advertisers are ranked according to the amount of their bid. This scheme is deficient as it allows an advertiser to simply bid more for a keyword to guarantee their advertisement is shown in response to submission of a given keyword by a user. This scheme may also reduce the value generated to the advertisers. The rank-by-revenue scheme ranks advertisers according to the product of their bid multiplied by their “click-though rate”, which is an estimate of the rate at which users click an advertisement, which may be normalized for position.

Both models are not optimal in terms of revenue generated for a search engine. As previously stated, the rank-by-bid model suffers from advertisers with low click-through rates flooding the bid list and wasting advertising space with unwanted advertisements. Although the bid price is higher for these advertisements, they are not selected often, thus degrading the amount of revenue generated for the advertisement provider (e.g., search engine). The rank-by-revenue approach results in a less than optimal solution as it results in lower payments by advertiser; also diminishing the revenue that an advertisement provider generates.

### SUMMARY OF THE INVENTION

The present invention is directed towards systems and methods for shaping relevance scores for use in ranking position auctions. The system of the present invention comprises a network communicatively coupled to a plurality of user devices and a plurality of advertiser devices. A content server is further coupled to the network and is operative to receive search queries from said user devices and provide advertisements based upon a derived priority score for each advertisement. In accordance with one embodiment, advertisements are distributed among vacant slots of a search results page.

The content server may comprise a query analyzer operative to receive search queries and extract relevant keywords (which may include groups or clusters of keywords), a rank generator operative to determine said quality score for an advertisement and an ad generator operative to generate advertisements corresponding to a user search query.

The rank generator receives a list of advertisements from the ad generator, receives corresponding advertisement bids from a bid data store and receives corresponding click through data from a click data store. In one embodiment, the derived priority score comprises multiplying an advertiser bid by the result of a monotone, concave function applied to the click through data. In an alternative embodiment, the derived priority score comprises utilizing bid credits for advertiser bids. The derived priority score may be computed at runtime, although alternative embodiments exist where the derived priority score is computed prior to submission of a user search query.

The present invention is further directed towards a method for ranking advertisements in a position auction. The method of the present invention comprises receiving a search query and selecting at least one keyword based upon said search query. In accordance with one embodiment, a user search query is received via a query entered into an HTML form element.

A list of at least one advertisement corresponding to at least one keyword identified and a priority score is computed corresponding to each advertisement in the list. In one embodiment, the priority score is a product of an advertiser bid and a monotone, concave function applied to click through data corresponding to said advertisement. In an alternative embodiment, the priority score is computed by assigning bid credits for each advertiser. The priority score may be computed at runtime, although alternative embodiments exist where derived priority score is computed prior to a user search query is submitted.

After calculating a priority score for one or more advertisements, the advertisements are ranked according to the calculated priority score and at least one of the retrieved advertisements corresponding to the highest ranked priority score is provided to the user. In accordance with one embodiment, advertisements are distributed among vacant slots of a search results page. In one embodiment, advertisers are charged a price equal to the minimum price necessary to keep a current ranked position, plus a small optional increment. This pricing rule is referred to as the “next price” or, alternatively, “generalized second price” auction rule.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating one embodiment of a system for dynamically or statically ranking and providing advertisements in a position auction;

FIG. 2 presents a flow diagram illustrating one embodiment of a method for dynamically ranking and providing advertisements in a position auction; and

FIG. 3 presents s a flow diagram illustrating one embodiment of a method for statically ranking and providing advertisements in a position auction.

### DETAILED DESCRIPTION OF THE PREFERRED EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

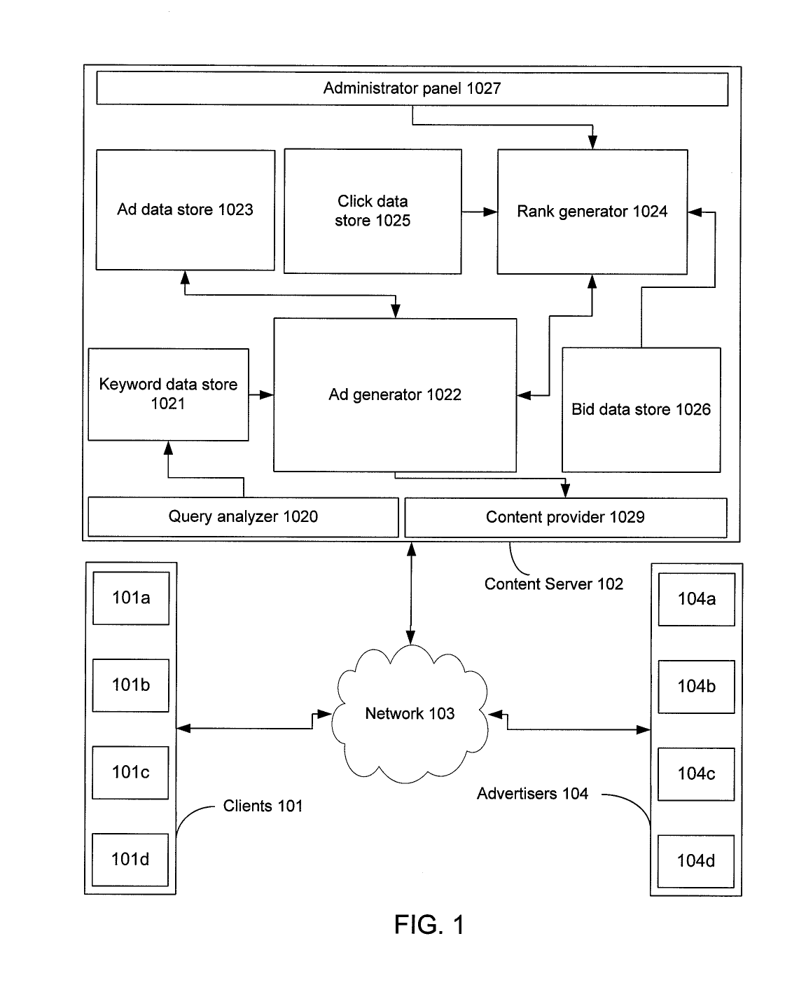

FIG. 1 presents a block diagram depicting one embodiment of a system for shaping relevance scores for position auctions. According to the embodiment illustrated in FIG. 1, a system for shaping relevance scores for position auctions comprises clients 101, advertisers 104, content server 102 and a network 103.

According to the embodiment illustrated in FIG. 1, client devices 101a, 101b, 101c and 101d are communicatively coupled to a network 103, which may include a connection to one or more local and wide area networks, such as the Internet. According to one embodiment of the invention, a client device 101a, 101b, 101c and 101d is a general purpose personal computer comprising a processor, transient and persistent storage devices operable to execute software such as a web browser, peripheral devices (input/output, CD-ROM, USB, etc.) and a network interface. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Advertisers 104a, 104b, 104c and 104d are communicatively coupled to the network 103.

Content server 102 is also communicatively coupled to network 103 and is operative to receive data from client devices 101 and advertisers 104. In one embodiment, the content server 102 is operative to receive search queries from client devices 101. Search queries may be in the form of text strings, e.g., keywords, which a user may enter into an HTML form element such as a text box. Content server 102 may further be operative to return search results to a client 110a, 101b, 101c and 101d, as well as advertisements. In addition to communicating with the client devices 101, content server 102 may be further operative to communicate with advertisers 104. In one embodiment, the content server 102 may be operative to receive bid information for a search keyword from one or more advertisers 104. Additionally, content server 102 may be operative to return statistical data regarding an advertiser to said advertiser. In alternative embodiments, the content server 102 may be operative to communicate other relevant data to and receive other relevant data from a given advertiser 104, including, but not limited to, billing information, analytics information and any other relevant information known in the art.

Content server 102 comprises a query analyzer 1020, keyword data store 1021, ad generator 1022, ad data store 1023, rank generator 1024, click data store 1025, bid data store 1026, administrator panel 1027 and content provider 1028. An advertiser 104a, 104b, 104c and 104d places a bid by submitting a bid request to content server 102. A bid corresponds to an amount paid per user interaction, such as a user click. In one embodiment, the content server 102 provides a list of available keywords stored in keyword data store 1021. Alternatively, an advertiser 104a, 104b, 104c and 104d may be able to select keywords not present in keyword data store 1021. After an advertiser 104a, 104b, 104c and 104d selects the desired keywords, a bid is submitted and stored within bid data store 1026.

After a keyword is selected by an advertiser 104a, 104b, 104c and 104d, a corresponding advertisement is selected by an advertiser 104a, 104b, 104c and 104d and submitted to the content server 102 for storage within an advertisement data store 1023. In accordance with some embodiments, an advertisement that an advertiser 104a, 104b, 104c and 104d submits may be a textual advertisement comprising a product title, brief product description and a URL containing the product details. In alternative embodiments, an advertiser 104a, 104b, 104c and 104d may submit advertisements that comprise graphical information, audio information, video information or any advertising medium known to those of skill in the art.

When a user submits a query using a web search engine, query analyzer 1020 receives the search query from the user. Query analyzer 1020 may determine the keywords contained within a received user query. For example, if a user enters the query “Tottenham Hotspur tickets”, query analyzer 1020 may determine the query contains two keywords, the team “Tottenham Hotspur” and the object “tickets”. Query analyzer 1020 determines keywords that a query contains by querying keyword data store 1021. Determining groups of semantically related terms from a query comprising one or more keywords may be conducted in accordance with the systems and methods described in commonly owned U.S. Pat. No. 7,051,023, entitled “SYSTEMS AND METHODS FOR GENERATING CONCEPT UNITS FROM SEARCH QUERIES,” filed on Nov. 12, 2003, the disclosures of which is hereby incorporated by reference herein in its entirety. Keyword data store 1021 may comprise a flat data file, relational database, object oriented database or other storage means known in the art. If a match is found within the keyword data store 1021, the match is forwarded to ad generator 1022.

After ad generator 1022 receives the keywords, the ad data store 1023 is queried for advertisements corresponding to or otherwise matching the extracted keywords. Ad data store 1023 may comprise a flat data file, relational database, object oriented database or other storage means known in the art. In one embodiment, the advertisements stored within ad data store 1023 may comprise textual advertisements containing an advertisement title (such as “Discount Airline Ticket”), a description supplementing the title (such as “Find low airfares & discount tickets on American Airlines at AA.com.”) and a URL associated with the advertisement (such as “www.aa.com”). Ad data store 1023 may also maintain other advertisement media known to those of skill in the art.

When advertisements corresponding to the received keywords are retrieved, rank generator 1024 may order the advertisements by priority score. According to one embodiment, the rank generator 1024 receives the keyword from the ad generator 1022 and fetches a bid list from bid data store 1026. Bid data store 1026 may comprise a flat data file, a relational database, an object oriented database or any storage method known in the art. Rank generator 1024 receives a list of advertisers bidding on a selected keyword and proceeds to determine a priority score for a given advertisement. Techniques for calculating the priority score in accordance with various embodiments of the invention are described in greater detail herein.

Rank generator 1024 is further communicatively coupled to click data store 1025. Rank generator 1024 receives click rate data from click data store 1025. Click data store 1025 contains information relating to user interaction with one or more advertisements. In accordance with one embodiment, click rate data for a given advertisement may comprise a function of the number of impressions for a given advertisement and the number of times one or more users have clicked on the given advertisement in response to an impression for the given advertisement, which may be recorded whenever a user interacts with the given advertisement. In accordance with one embodiment, whenever a user clicks on a given advertisement hyperlink, data is returned to the content provider for storage in the click data store 1025 indicating that a user has selected the given advertisement. In turn, a counter is incremented indicating another user has selected the advertisement. Impression data is also returned to the click data store 1025 in response to the display of an advertisement to a user. Alternative embodiments may exist wherein additional data is collected in lieu of or in conjunction with the preceding example. Techniques for collecting information regarding advertisement impression and selection, such as redirection, are well known to those of skill in the art.

In accordance with one embodiment, the priority score of a given advertisement corresponds to the price of the bid multiplied by function whose input is the quality score an advertisement receives, as is Equation 1 below illustrates. The quality score may be a measure of the “clickability” or “relevance” for the given advertisement, which according to one embodiment is based on a position-normalized click through rate. The quality score may also comprise various combinations of an actual or estimated click through rate, clickability metric, relevance score, advertisement quality score, advertiser quality score, user satisfaction score or any other measure of advertisement quality. Additionally, the quality score may comprise one or more relevance features in addition to click through rate history, such as the appearance of query terms in a given advertisement.

$$Priority score = Bid * f ( quality score ) \qquad Equation 1$$

In accordance with one embodiment, the function “f” corresponds to a monotone, concave function. A monotone, concave function has the properties of increasing or decreasing as the input parameter increases or decreases and satisfies the equality of Equation two for any points x and y and any t=[0, 1]:

$$f ( tx + ( 1 - t ) y ) \geq tf ( x ) + ( 1 - t ) f ( y ) \qquad Equation 2$$

The use of a monotone, concave function allows the content server 102 to exert control over which advertisements are shown on a search results page at a finer granularity. According to another embodiment, a the system may utilize a convex function whereby the quality score is raised to a power “gamma” that is greater than 1, thereby “overweighting” clicks and giving a bigger discount than a pure ranking. By utilizing a server defined function, the server may set the function so that enough value is generated to the advertiser while still keeping payments high enough to ensure enough revenue is generated by the content server 102.

In accordance with an alternative embodiment, a monotone, concave function may be replaced with the use of “bidding credits” that the content server 102 provides to advertisers 104a, 104b, 104c and 104d. In accordance with this embodiment, the content server 102 may only require that an advertiser 104a, 104b, 104c and 104d pay a fraction of the prices they face, or equivalently a fraction of their clicks may be received for free. The use of “bidding credits” achieves an identical result to that obtained by using a monotone, concave function. Bidding credits, however, may allow the content server 102 to avoid explicitly setting the weight of user clicks through a function.

As shown in FIG. 1, rank generator 1024 is further communicatively coupled to administrator panel 1027. Administrator panel 1027 is operative to allow a server administrator to configure the properties of at least the rank generator 1024. In accordance with one embodiment, a server administrator may modify the function represented by “f” in Equation 1. For example, an administrator may determine that f(quality score) may be set as log(quality score) and may set the appropriate value of f in the rank generator 1024.

The rank generator 1024 orders the advertisements by priority score and one or more of the ordered advertisements are selected for display to the user. The number of advertisements that the rank generator 1024 selects may correspond to the number of free advertising slots available on a website, e.g., a search result page that a search engine produces. For example, a search results page may contain three slots corresponding to the top, right hand side and bottom of the page. In accordance with one embodiment, the highest ranking advertisement is placed in the most visible advertising slots. The advertising slot located at the top of a search result page may be considered the most visible advertising slot, therefore, the advertisement or advertisements with the highest quality score may be placed in these one or more slots. Subsequently, advertising slots to the right of the returned search results may be determined to be the second most visible slots, and one or more remaining advertisement from the ranked list may be placed in this slot. Finally, a slot at the bottom of a page of search results may be determined to be the least visible slot and therefore will be filled last. It should be noted by those of skill in the art that embodiments of the present invention are not limited to placement of ranked advertisements on a search result page and may be applicable to any systems that utilize ranked lists of items in which users pay for placement of items in the list, e.g., a real estate listing site, personals/dating site, etc.

Advertisements and slot positions may be sent to content provider 1029. Content provider 1029 may be operative to combine the advertisements with the data in the query result set, returning the combined resource to clients 110a, 101b, 101c and 110d across the network 103.

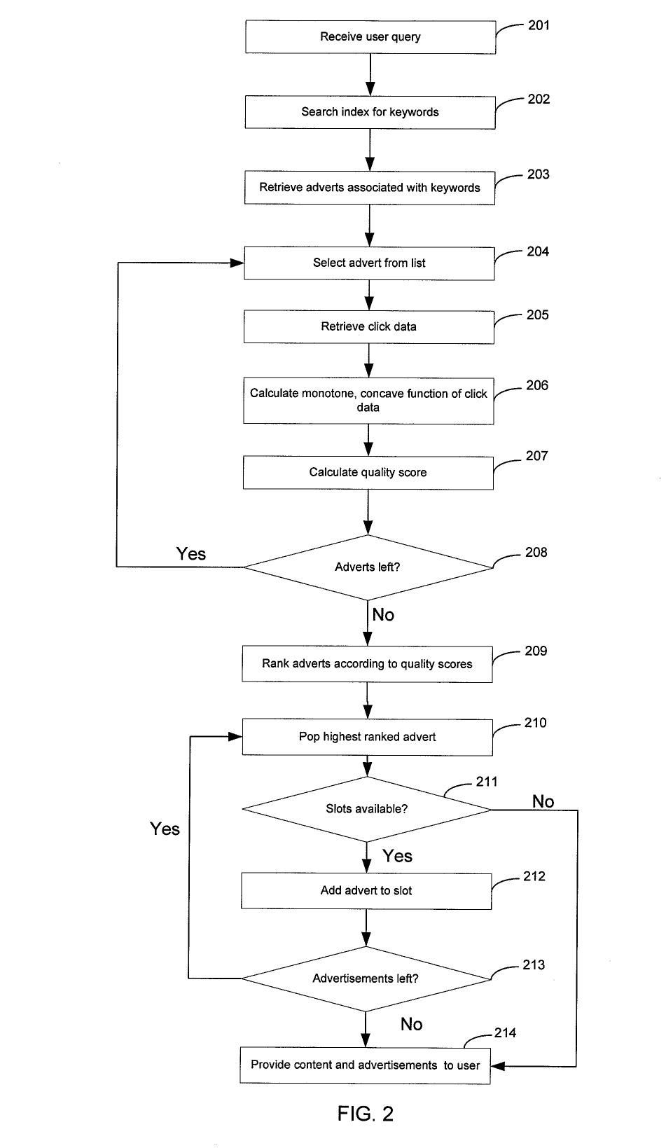

FIG. 2 is a flow diagram illustrating one embodiment of a method for dynamically ranking and providing advertisements in a position auction. A user query is received, step 201, which may correspond to the search terms requested of a search engine, such as through an HTML text box. After a user query is received, an index is searched for corresponding keywords, step 202. For example, if an index of keywords contains the terms “Tottenham”, “tickets”, “soccer” and “London” and a user query comprises “tottenham hotspur tickets”, the keywords “Tottenham” and “tickets” will be extracted from the user query. The extraction of keywords from a given user query may be performed in accordance with the systems and methods described in the applications previously incorporated herein by reference in their entirety. Extracted keywords may attempt to represent a user query with a minimal dictionary of terms understandable by a server system.

After at least one keyword is extracted from the user query, a list of advertisements corresponding to the keyword are retrieved, step 203. Given a list of advertisements, a first advertisement is selected from the list of advertisements, step 204. The choice of an advertisement is inconsequential, as the present embodiment contemplates traversal of the list and the analysis of advertisements contained therein. For the selected advertisement, click rate data corresponding to the advertisement is retrieved, step 205. In accordance with one embodiment, click rate data for an advertisement may comprise the number of times users have clicked on the selected advertisement (or may more generally comprise the recordation of a user interaction with the advertisement, e.g., a mouse over event) in conjunction with the number of impressions for the selected advertisement. Whenever a user clicks on an advertisement hyperlink or the advertisement is shown to the user, data may be returned to the advertisement provider indicating a user has selected the advertisement or viewed the advertisement, respectively. Alternative embodiments may exist wherein additional data is collected in lieu of or in conjunction with the preceding example.

After click through rate data is retrieved in step 204, a monotone, concave function may be applied to the click data, step 205. A monotone, concave function has the properties of increasing or decreasing as the input parameter increases or decreases and satisfies the equality f(tx+(1−t)y)≧tf(x)+(1−t)f(y) for any points x and y and any t=[0, 1]. The use of a monotone, concave function allows the advertisement provider to maintain a finer granularity of control over the advertisements provided on the search results page. For example, a function of the form f(x)=log(x+c); for c>0 is an example of a monotone, concave function which may be utilized to “cap” the effect of the click through rate. That is, log(x) increments one unit (0→1) over the range of inputs 1 to 10. Log(x) then increments one more unit (1→2) over the interval 10 to 100. This property of the log function may prevent an advertiser from having a bloated quality score, as the nature of the logarithmic function will require a tremendous amount of clicks to increase the quality score as clicks are accumulated. An alternative example is provided by the function f(x)=x^{c}, for 0<=c<=1. The preceding examples are intended to be exemplary in nature, and a number of other functions may be utilized, as decided by a server administrator, other server side technician or automated software process.

After the results of the monotone, concave function are calculated in step 206, a final priority score is determined for the selected advertisement, step 207. In accordance with one embodiment, a priority score is calculated by multiplying the advertiser bid amount by the result of the monotone, concave function calculation. After the priority score is determined, the list of advertisements is queried to determine if there are additional advertisements remaining in the list of advertisements that are responsive to the user keywords, step 208. If advertisers remain in the list, program flow returns to step 204 and the process is repeated for the next advertisement.

If priority scores have been computed for advertisements in the list, the advertisements are ranked according to the computed quality scores, step 209. The list of advertisements and priority scores may be ranked via any sorting algorithm known to one of ordinary skill in the art, such as quick sort, merge sort, heap sort, etc.

The ordered and ranked advertisements may be placed within a search result page framework, steps 210-213, or any other content page framework. The highest ranked advertisement is popped from the stack of ranked advertisements, step 210, and a determination is made as to whether a free slot exists on the search results page, step 211. As previously described, a search results page may comprise multiple positions for advertisements such as the top of the page, the bottom of the page and the right hand side of the search results, etc. If no slots are available the page has been filled with the advertisements and the advertisements are provided along with the search results, step 214.

If at least one empty slot exists, the selected advertisement is placed within the open slot, step 212. A check is then performed to determine whether there are additional advertisements for placement that remain, step 213. In some cases, there may be more slots than advertisements due to the lack of interest in certain keywords. In this case, advertisements are supplied to the content page and empty slots may remain. Alternatively, where there are more advertisements than available slots, one or more selected advertisements may not be placed on the page. Once all advertisements have been supplied (or all slots filled), the search results and advertisements are provided to the user, step 214.

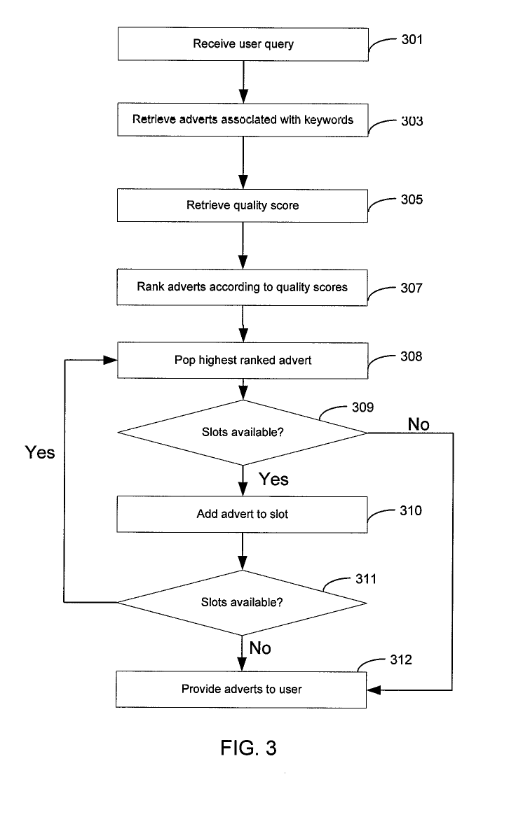

FIG. 3 is a flow diagram illustrating one embodiment of a method for statically ranking and providing advertisements in a position auction. A user query is received, step 301. A user query may correspond to the search terms requested of a search engine, such as through an HTML text box. A list of advertisements corresponding to the one or more keywords is retrieved, step 303, in conjunction with priority scores for corresponding advertisements, step 305.

The priority score retrieved in step 305 may be calculated prior to the execution of the user search. For example, in accordance with one embodiment, a batch process may be run which calculates the priority scores for advertisers corresponding to a search keyword. By calculating the priority scores as a batch process, the execution of a user search (and subsequently the speed at which results are returned) may be optimized as the computing power utilized by the steps of computing priority scores for a given advertiser on the fly is removed.

The advertisements may be ranked according to the priority scores, step 307. The ranked advertisements may then be placed within a search result page framework, steps 308-311. The highest rank advertisement may be popped from the stack of ranked advertisements, step 308. It is then determined if a free slot exists on the search results page, step 309. As previously described, a search results page may comprise multiple positions for advertisements. If no slots are available, the page has been filled with the highest quality advertisements and the advertisements are provided along with the search results, step 312.

If there one or more empty slots exist on the page, the selected advertisement is placed within the open slot, step 310. A check is then performed to determine whether there are any more advertisements remaining, step 311. In some cases, there may be more slots than advertisements due to the lack of interest in certain keywords, or vice versa. In this case, advertisements are supplied to the content page and empty slots remain unfilled. Once advertisements have been supplied (or slots filled), the search results and advertisements are provided to the user, step 312.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A system for ranking and providing advertisements in a position auction, the system comprising:
a network;
a plurality of user devices coupled to said network;
a plurality of advertiser devices coupled to said network; and
a content server coupled to said network operable to receive search queries from said user devices and provide advertisements based upon a derived priority score for each advertisement.

2. The system of claim 1 wherein said content server further comprises:
a query analyzer operative to receive search queries and extract relevant keywords;
a rank generator operative to determine said priority score for an advertisement; and
an ad generator operative to generate advertisements corresponding to a user search query.

3. The system of claim 2 wherein said rank generator is operative to receive a list of advertisements from said ad generator, receive advertisement bids from a bid data store and to receive click through data corresponding to an advertisement from a click data store.

4. The system of claim 3 wherein the derived priority score comprises multiplying an advertiser bid by the result of a monotone, concave function of the click through data.

5. The system of claim 3 wherein the derived priority score comprises utilizing bid credits for advertiser bids.

6. The system of claim 1 wherein the derived priority score is computed at runtime.

7. The system of claim 1 wherein the derived priority score is computed prior to a user search query is submitted.

8. The system of claim 5 wherein the derived priority score is computed at runtime.

9. The system of claim 5 wherein the derived priority score is computed prior to a user search query is submitted.

10. The system of claim 2, wherein said rank generator is further coupled to an administrative panel operative to configure said rank generator.

11. The system of claim 1, wherein said provided advertisements are distributed among vacant slots of a search results page.

12. A method for ranking advertisements in a position auction comprising:
receiving a search query;
selecting at least one keyword based upon said search query;
retrieving a list of at least one bid corresponding to said at least one keyword;
computing a priority score corresponding to an advertisement associated with a given bid in said list, the priority score comprising the product of the bid and a monotone, concave function of click through data corresponding to said advertisement;
ranking said advertisements according to said quality score.

13. The method of claim 12, wherein a search query comprises a user search query entered into an HTML form element.

14. The method of claim 12, wherein said priority score is computed by assigning bid credits for each advertiser.

15. The method of claim 12 wherein said priority score is determined at runtime.

16. The method of claim 12 wherein said priority score is determined prior to a user search query is received.

17. The method of claim 14 wherein said priority score is determined at runtime.

18. The method of claim 14 wherein said priority score is determined prior to a user search query is received.

19. The method of claim 12, wherein said computation of a priority score is determined by a system administrator.

20. The method of claim 12, wherein said provided advertisements are distributed among vacant slots of a search results page.
